(19) United States
(12) Patent Application Publication
(10) Pub. No.: US 2003/0174744 A1
(43) Pub. Date: Sep. 18, 2003

(54) Digital control of burst mode laser

(76) Inventor: Timothy J. Reilly, Plymouth, MN (US)

Correspondence Address: SHUMAKER & SIEFFERT, P. A., 8425 SEASONS PARKWAY, SUITE 105, ST. PAUL, MN, 55125, US

(21) Appl. No.: 10/096,816

(22) Filed: Mar. 13, 2002

(51) Int. Cl. H01S 3/13; H01S 3/00

(52) U.S. Cl. 372/32; 372/33

(57) ABSTRACT

A digital burst mode laser control technique permits maintenance of a substantially constant laser output power for burst mode operation of a laser at lower duty cycles. The control technique may involve measurement of the output power level of a burst mode laser during a first burst frame, and comparison of the measured power level to a target power level. In addition, the control technique may further involve adjustment of a digital value based on the comparison, and conversion of the digital value to an analog value to control the output power level of the burst mode laser during a second burst frame. Hence, the control technique uses the output power level measured in a first burst frame to control the output power level of the burst mode laser during a subsequent burst frame.

### TECHNICAL FIELD

The invention relates to laser driver control and, more particularly, control of burst mode laser drivers.

### BACKGROUND

A burst mode laser, in contrast to a continuous mode laser, produces output only during selected intervals. Many laser driver control circuits employ an analog control loop to maintain a constant average output power from the laser. A power monitor photodiode senses the output power of the laser for feedback to the driver control circuit. In particular, the power monitor photodiode typically generates a current that is proportional to the output power of the laser.

The driver control circuit may include an analog loop that compares the photodiode current to a reference current value. Based on the comparison, the driver control circuit adjusts laser drive current to reduce the error between the photodiode current and the reference current. In some circuits, as an alternative, the photodiode current is applied to a resistor to produce a monitor voltage indicating the output power of the laser. The driver control circuit then compares the monitor voltage to a reference voltage, and controls the laser drive current to reduce error.

In a burst mode laser system, the control loop must be maintained during laser “off” time, i.e., between bursts. When the laser bursts “on,” the control loop must be ready to control the drive current to the laser for rapid convergence to the desired output power level. In some applications, however, the burst mode duty cycle of the laser can be very low. Accordingly, the laser may be turned “off” most of the time, requiring longer-term maintenance of the control loop. Analog control loops typically provide a sample and hold circuit to hold a drive value. However, sample and hold circuits may have significant difficulty operating at very low duty cycles.

### SUMMARY

In general, the invention is directed to digital techniques for control of a burst mode laser. More particularly, the invention is directed to digital control techniques capable of maintaining a substantially constant laser output power for burst mode operation of a laser at lower duty cycles. For example, the invention may be especially advantageous for burst mode lasers having extremely low duty cycles, including without limitation duty cycles of less than 1 percent and as low as approximately 0.003 percent.

Extremely low duty cycles are present in high-speed communication networks that require time division multiplexing of burst transmissions from multiple network nodes. One example of such a network is a passive optical network in which multiple nodes share a common optical fiber link for transmission of voice and data. In a passive optical network, nodes often transmit information in extremely short bursts, e.g., less than approximately 3 microseconds, with extremely low duty cycles, e.g., less than approximately 1 percent and as low as approximately 0.003 percent.

According to an exemplary embodiment, a digital control technique may involve measurement of the output power level of a burst mode laser during a first burst frame, and comparison of the measured power level to a target power level. In addition, the control technique may further involve adjustment of a digital value based on the comparison, and conversion of the digital value to an analog value to control the output power level of the burst mode laser during a second burst frame.

Hence, the digital control technique uses the output power level measured in a first burst frame to control the output power level of the burst mode laser during a subsequent burst frame. The control technique maintains a representation of the error between the output power level and the target power level by adjusting a digital value, and converts the digital value to an analog value for use in a subsequent burst frame to control the output power level. As used herein, the term “frame” may refer to a period of time in which a burst mode laser is turned “on,” whether the laser is modulated with data during that time or not.

The use of a digital value eliminates the need for analog sample-and-hold circuitry to maintain the control loop during laser “off” time, and generally avoids the difficulties encountered by such circuitry when operating at lower duty cycles. In addition, adjustment of the digital value can be synchronized with the end of the burst frame so that the time needed for comparison of the output power level and the target power level can span the preceding burst frame, if necessary. In this way, there is ample settling time for the measured power level and comparison.

The digital value may take the form of a digital counter value that is incremented or decremented based on the results of the comparison of the output power level and target power level. The digital counter that holds the digital counter value can be clocked in synchronization with the end of a burst frame to update the counter value based on the comparison. The digital counter outputs the stored counter value for digital-to-analog conversion. The resulting analog value then can be used to control a bias current. In turn, the bias current can be used to control a drive current provided to the laser during the next burst frame.

In one embodiment, the invention provides a method comprising comparing the measured output power level of a burst mode laser to a target power level, adjusting a digital value based on the comparison, and controlling the output power level of the burst mode laser during a subsequent burst frame based on the adjusted digital value.

In another embodiment, the invention provides a system comprising a burst mode laser, and a power monitor that measures an output power level of the burst mode laser during a first burst frame. In addition, the system includes a power controller that compares the measured power level to a target power level, adjusts a digital value based on the comparison, and controls the output power level of the burst mode laser during a second burst frame based on the digital value.

In an added embodiment, the invention provides a system comprising means for comparing the measured output power level of a burst mode laser to a target power level, means for adjusting a digital value based on the comparison, and means for controlling the output power level of the burst mode laser during a second burst frame based on the adjusted digital value.

In a further embodiment, the invention provides a method comprising comparing the measured output power level of a burst mode laser during a first burst mode frame to a target power level, stepping a digital counter value in a first direction if the output power level is greater than the target power level, and stepping the digital counter value in a second direction if the output power level is less than the target power level. The method further includes converting the digital counter value to an analog voltage to control a drive current applied to the burst mode laser during a second burst frame. The burst mode frame may have a duty cycle of less than approximately 1 percent and as low as approximately 0.003 percent. The burst mode frames may have durations ranging from approximately 3 microseconds to 1 millisecond, depending on the applicable bit rate and application protocol.

In another embodiment, the invention provides a passive optical network. The network comprises a plurality of network nodes, and a passive optical network interface coupled to the nodes, at least in part, by a shared optical fiber link. The network nodes transmit information to the passive optical network interface in bursts. In addition, each node includes a burst mode laser, a power monitor that measures an output power level of the burst mode laser during a first burst frame, and a power controller that compares the measured power level to a target power level, adjusts a digital value based on the comparison, and controls the output power level of the burst mode laser during a second burst frame based on the digital value.

The invention may provide one or more advantages. By using a digital value to represent error, the control loop can be maintained indefinitely, even for extremely low duty cycles. In particular, the control technique does not suffer from the hold times and leakage current typically associated with analog sample-and-hold circuitry. In addition, the counter can be readily implemented in low-cost integrated circuitry, e.g., ASIC or FPGA. Also, the comparison of the measured power level to the target power level may be accomplished at any time during a preceding burst frame, permitting ample settling time for the voltages present at the anode of the monitoring diode. As a further advantage, the digital counter can be initialized at startup to hold the last counter value prior to power-down. This feature can reduce the number of burst frames necessary for the power control loop to stabilize and converge to the desired output power upon power-up of the laser.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary passive optical network.

FIG. 2 is a block diagram illustrating a digital burst mode laser control loop.

FIG. 3 is a schematic diagram illustrating a control loop as shown in FIG. 2 in greater detail.

FIG. 4 is a schematic diagram illustrating an alternative configuration of the control loop of FIG. 3.

FIG. 5 is a timing diagram illustrating operation of the control loop of FIG. 3.

FIG. 6 is a flow diagram illustrating a digital burst mode laser control technique.

FIG. 7 is a flow diagram illustrating the technique of FIG. 6 in greater detail.

### DETAILED DESCRIPTION

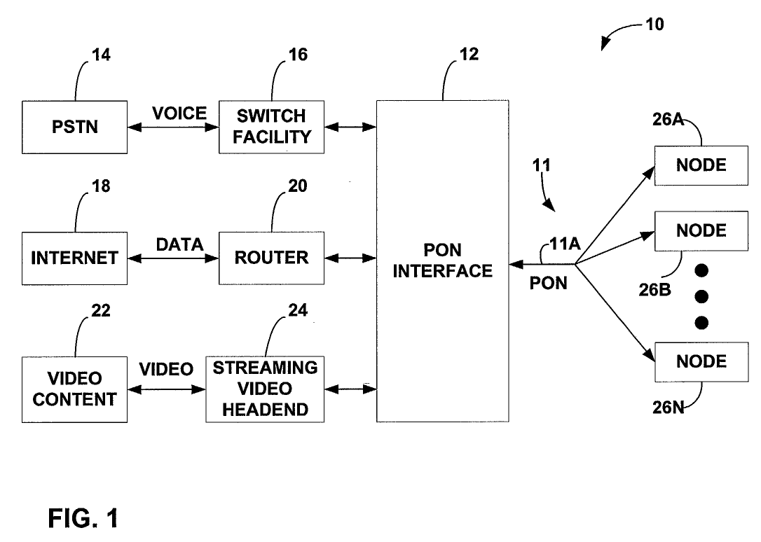

FIG. 1 is a block diagram illustrating a passive optical network (PON) 10. As will be described, various components of PON 10 may incorporate digital burst mode laser control loops in accordance with the invention. PON 10 can be arranged to deliver voice, data and video content (generally “information”) to a number of network nodes via optical fiber links 11. For example, a PON interface 12 may receive voice information from the public switched telephone network (PSTN) 14 via a switch facility 16. In addition, PON interface 12 may be coupled to one or more internet service providers (ISP's) on Internet 18 via a router 20. As further shown in FIG. 1, PON interface 12 may receive video content 22 from video content suppliers via a streaming video headend 24. In each case, PON interface 12 receives the information, and distributes it along one of optical fiber links 11 to one or more nodes 26A through 26N, hereinafter referred to as nodes 26.

Nodes 26 include hardware for receiving information from PON 10 via optical fiber links 11, and delivering the information to devices within a local area network (LAN) associated with the node. For example, each node 26 may serve as a PON access point for one or more computers, appliances, televisions, wireless devices, or the like. PON interface 12 may be located near or far from a set of nodes 26. A node 26 may be located at any of a variety of locations, including residential or business sites. In addition, a single node 26 may operate on a shared basis to deliver information to two or more closely located residences or businesses via copper or additional optical fiber connections, either directly or via a network hub, router or switch.

Nodes 26 also include hardware for transmitting information over PON 10. For example, a node 26 may transmit voice information over PSTN 14 via PON interface 12 in the course of a telephone conversation. In addition, a node 26 may transmit data to a variety of network nodes on Internet 18 via PON interface 12. Multiple nodes 26 typically transmit over a common optical fiber link 11A using time division multiplexing techniques. For this reason, nodes 26 operate in a burst mode to transmit periodically during selected time slots. In particular, nodes 26 include burst mode lasers that are modulated to encode information for delivery over PON 10. The burst mode laser turns on and off periodically to transmit during a time slot assigned to the respective node 26.

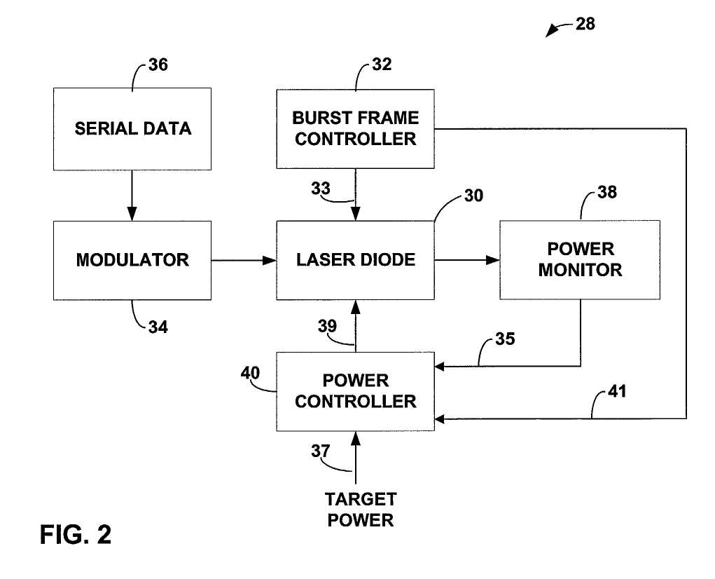

FIG. 2 is a block diagram illustrating a digital burst mode laser control loop 28. As one example, control loop 28 may reside within a node 26 in a PON 10 as shown in FIG. 1. Alternatively, control loop 28 may be used in a variety of systems requiring control of a burst mode laser, and especially those characterized by low duty cycles.

As shown in FIG. 2, system 28 may include a burst mode laser diode 30 that is responsive to a burst frame controller 32. In particular, burst frame controller 32 generates a burst frame pulse, indicated by reference numeral 33, that turns laser diode 30 “on.” During the “on” period, a modulator 34 modulates laser diode 30 to encode a stream of serial data 36. The encoded output signal emitted by laser diode 30 travels along optical fiber links 11 to PON interface 12, and is routed to the appropriate destination, e.g., PSTN 14 or Internet 18.

As used herein, the term “frame” may refer to a period of time in which laser diode 30 is turned “on,” whether the laser diode 30 is modulated with data during that time or not. The duration of the burst frame typically may range from approximately 3 microseconds to 1 millisecond, depending on the applicable bit rate and application protocol. In one exemplary application, the burst frame minimum duration may be on the order of 2.89 microseconds. The burst frame period typically may range, for example, from approximately 1 to 100 milliseconds.

A power monitor 38 measures the output power of laser diode 30. Power monitor 38 may take the form of a back facet monitor photodiode, and may be integrated with laser diode 30 in a common package. A power controller 40 receives a signal, indicated by reference numeral 35, from power monitor 38 indicating the output power level of laser diode 30. Power controller 40 compares the measured output power level to a target power level, indicated by reference numeral 37, and outputs a control signal to control laser diode 30 to maintain a desired output power level, as indicated by reference numeral 39.

Power controller 40 also may be responsive to burst frame controller 32, as indicated by reference numeral 41. In particular, in accordance with the invention, power controller 40 may be configured to control the output power level of laser diode 30 during a burst frame based on the output power level measured in a preceding burst frame. As will be described, power controller 40 uses a digital value to maintain power control between successive bursts, i.e., during the “off” time of laser diode 30.

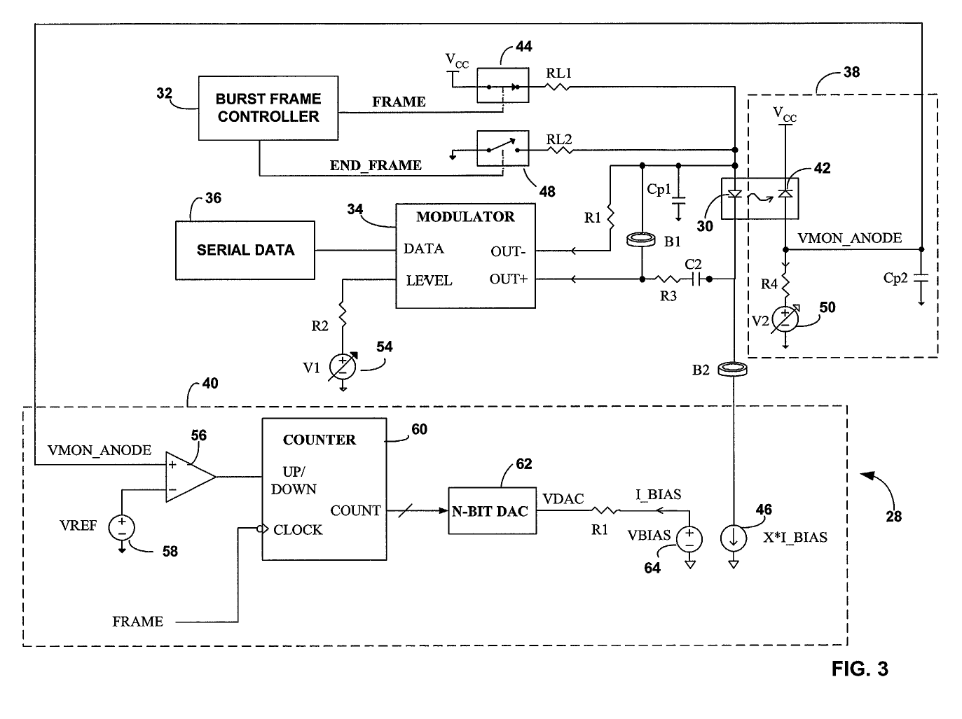

FIG. 3 is a schematic diagram illustrating an example embodiment of digital burst mode control loop 28 of FIG. 2 in greater detail. As shown in FIG. 3, laser diode 30 may reside in a common package with a back facet monitor photodiode 42 that measures the output power of the laser diode. Moreover, laser diode 30 and monitor photodiode 42 may form part of a bi-directional (BiDi) laser module that is able to transmit and receive information over a single optical fiber, as is well known in the art. Monitor photodiode 42 measures the output power level of laser diode 30, and generates a signal indicative of the measured power level.

Burst frame controller 32 generates a “FRAME” pulse that indicates when laser diode 30 should burst “on.” In particular, when the FRAME pulse is high, switch 44 closes to connect the anode of laser diode 30 to power line V_{CC} via current limit resistor RL1. When laser diode 30 is coupled to V_{CC}, power controller 40 is able to apply a driver current to laser diode 30 via a current source 46. As will be described, power controller 40 sets the driver current based on the output power level of laser diode 30, as measured by monitor photodiode 42. The driver current causes laser diode 30 to emit optical power for the duration of the FRAME pulse. A ferrite bead B2 may be coupled between current source 46 and the anode of laser diode 30. The ferrite bead allows bias current to set the average level of laser diode output, yet presents a high impedance to the modulating signal.

During the “on” time, modulator 34 modulates the output of laser diode 30 based on a stream of serial data 36. A voltage source 54 and resistor R2 set the modulation level of modulator 34. The negative output (OUT−) of modulator 34 applies current to the anode of laser diode 30 via resistor R1. The positive output (OUT+) of modulator 34 receives current from the cathode of laser diode 30 via resistor R3 and capacitor C2. The negative and positive outputs are synchronized to produce a series of bit transitions in the output of laser diode 30 based on the stream of serial data 36 applied to modulator 34. A ferrite bead B1 may be coupled across the positive and negative outputs of modulator 34 to create a DC bias for the modulator. The output of laser diode 30 is coupled to optical fiber links 11 and transmitted along PON 12 as shown in FIG. 1.

When the FRAME pulse is low, switch 44 opens and disconnects the anode of laser diode 30 from power line V_{CC}. Disconnection from power line V_{CC} turns the laser diode “off.” Following disconnection of laser diode 30 from V_{CC}, however, current may continue to flow through the laser diode for a short period of time due to parasitic capacitance Cp1. To rapidly remove the current from laser diode 30, burst frame controller 32 also generates an “END_FRAME” pulse. When the END_FRAME pulse is high, switch 48 closes to connect the anode of laser diode 30 to ground via current limit resistor RL2. Switch 48 shunts the anode of laser diode 30 to ground, and rapidly removes any remaining current. In this manner, the END_FRAME pulse causes a rapid fall time in the optical power emitted by laser diode 30. Without the END_FRAME pulse and switch 48, the fall time could be undesirably slow due to energy stored in parasitic capacitor Cp1, degrading burst mode response time.

In response to optical energy received from the back facet of laser diode 30, monitor photodiode 42 generates a measurement current. As will be described, control loop 28 is designed to maintain a substantially constant optical power from laser diode 30 based on feedback from monitor photodiode 42. For example, the output power of laser diode 30 may be represented as K_{—}1d Watts/A. Monitor photodiode 42 has a transfer function represented as K_md Amps/Watt_laser_power. Thus, monitor photodiode 42 generates a current that is proportional to the power output from laser diode 30. The measurement current from the anode of monitor photodiode 42 flows to a voltage V2 set by variable voltage source 50 across resistor R4, and generates a measurement voltage at the anode labeled “VMON_ANODE” in FIG. 3.

Power monitor 38 feeds back the VMON_ANODE signal to power controller 40. In particular, the VMON_ANODE signal is applied as an input to a comparator 56. Comparator 56 compares the VMON_ANODE signal, indicative of actual laser output power, to a target power level VREF set by voltage source 58. Power controller 40 controls the output power level of laser diode 30 based on the difference between VMON_ANODE and VREF. With VREF fixed, the output power level of laser diode 30 can be set by controlling the amount of current generated by monitor photodiode 42 that is sunk to ground. In particular, the amount of current sunk to ground from monitor photodiode 42 determines the voltage level of VMON_ANODE. By sinking more of the current from monitor photodiode 42 to ground, control loop 28 is forced to increase the drive current applied to laser diode 30 in order to maintain VMON_ANODE at a level equal to VREF.

One way to control the amount of current sunk to ground from monitor photodiode 42 is to simply place a variable resistor between the anode of monitor photodiode 42 and ground. In this case, the current from monitor photodiode 42 would be proportional to the value of the variable resistor, i.e., 1/R where R is the value of the variable resistor. A deficiency of this scheme is that, with the current proportional to 1/R, the slope of the current would tend to infinity as R goes to zero. An alternative approach, illustrated in FIG. 3, is to make use of variable voltage source 50 with a fixed resistor R4. Variable voltage source 50 may take the form of a digital-to-analog converter.

The voltage VMON_ANODE reflects the average value of the optical power due to filtering of the current from monitor photodiode 42 by the combination of the time constant of parasitic capacitance Cp2 and the resistance of resistor R4. If the parasitic capacitance Cp2 is insufficient to filter the modulation, it may be supplemented by an additional capacitor. In the example of FIG. 3, the amount of current sunk from monitor photodiode 42 is approximately: (VREF−V2)/R4. Thus, by adjusting the level of voltage V2 generated by voltage source 50 in power monitor 38, the response of the overall control loop 28 can be adjusted. In particular, the transfer function of control loop 28 is a linear function of the voltage V2.

The operation of power controller 40 will now be described in greater detail. During the FRAME pulse, the voltage VMON_ANODE settles to its final value. By the end of the frame pulse, comparator 56 has determined if voltage VMON_ANODE is above or below the reference value VREF provided by voltage source 58. If voltage VMON_ANODE is above the reference voltage VREF, the output of comparator 56 is high, indicating that the optical power of laser diode 30 is greater than desired level. Conversely, if VMON_ANODE is less than the voltage VREF, the output of comparator 56 is low, indicating that the optical power of laser diode 30 is lower than a desired level.

The output of comparator 56 is either high or low, and feeds an up/down input of a digital counter 60 as a logic level of “1” or “0.” Intermediate scaling circuitry may be provided, if necessary, to scale down the output of comparator 56 to a logic level range suitable for counter 60. Notably, counter 60 is clocked on the falling edge of the FRAME pulse generated by burst frame controller 32. Accordingly, comparator 56 is selected to produce a stable value within the minimum duration of the FRAME pulse. In this manner, comparator 56 is able to use the entire FRAME pulse to produce a stable value indicating the output power of laser diode 30. This feature permits ample settling time for the voltage VMON_ANODE, and the output of comparator 56.

In response to a high level at the UP/DOWN input, counter 60 increments the existing counter value. Counter 60 can be preloaded with an initial counter value that is estimated to drive the output power of laser diode 30 to a desired level. Conversely, in response to a low level at the UP/DOWN input, counter 60 decrements the existing counter value. Counter 60 is designed to not roll over or under. Counter 60 feeds the value of counter 60 to a digital-to-analog converter (DAC) 62 as an N-bit digital value. Counter 60 may, for example, output a four-bit or eight-bit digital value. Counter 60 outputs the existing counter value as a new up/down input is received from comparator 56.

DAC 62 converts the digital counter value to an analog voltage VDAC. The range for VDAC can be selected to be less than or equal to VBIAS. The difference in voltage between VDAC and the voltage VBIAS generated by voltage source 64 determines the amount of current that flows across resistor R1. The amount of current flowing across resistor R1 is the bias current I_BIAS that serves to control the amount of drive current applied to laser diode 30 and, in turn, the level of output power from the laser diode. In particular, the bias current I_BIAS is applied to a drive circuit that sinks a drive current of X*I_BIAS from laser diode 30 to ground.

In the example embodiment of FIG. 3, the bias current I_BIAS is equivalent to (VBIAS−VDAC/R1). If VDAC and VBIAS are equal, no bias current I_BIAS flows across resistor R1, and no drive current flows across laser diode 30. DAC 62 holds the bias current I_BIAS constant at all times except immediately after the falling edge of the FRAME pulse, at which time counter 60 outputs a new counter value, which changes by plus or minus one bit. The drive circuit may take the form of any conventional laser driver that can be made responsive to bias current I_BIAS. Alternatively, the drive circuit could be designed to be responsive to a voltage input, rather than bias current I_BIAS. For example, the drive circuit containing current source 46 may be a commercially available integrated driver circuit having an I_BIAS input. An example of one suitable integrated driver circuit is the Maxim 3867 laser driver chip, commercially available from Maxim Integrated Products, Inc. of Sunnyvale, Calif.

In summary, monitor photodiode 42 produces a current that flows across resistor R4 to voltage source 50, creating monitor voltage VMON_ANODE. Comparator 56 compares the monitor voltage VMON_ANODE to a reference voltage VREF. If VMON_ANODE is greater than VREF, comparator 56 applies a high logic level to the up/down input of counter 60. If VMON_ANODE is less than VREF, comparator 56 applies a low logic level to the up/down input of counter 60. On the next falling frame pulse, counter 60 increments the existing counter value if the up/down input is high, and decrements the existing counter value if the up/down input if low. DAC 62 then receives the counter value from counter 60 and generates an analog voltage VDAC. The voltage VDAC determines the amount of bias current I_BIAS flowing from voltage VBIAS and across resistor R1. The bias current I_BIAS determines the drive current X*IBIAS sunk to ground from laser diode 30, and the resulting output power.

For some applications, the burst frame period may be extremely small. For example, the burst frame period may be less than approximately 205 nanoseconds for limited periods of time, as required for certain four byte bursts according to the G983.1 Full Service Access Network (FSAN) specification. A burst frame period of less than approximately 205 nanoseconds may present operational challenges given the time constant of a burst mode control loop as described herein. Accordingly, for a “special” case like that presented by the FSAN specification, burst mode control loop 28 may be frozen so that the digital value maintained by counter 60 is maintained constant. In particular, counter 60 may be inhibited from counting during extremely short bursts that are not typical of ordinary operation.

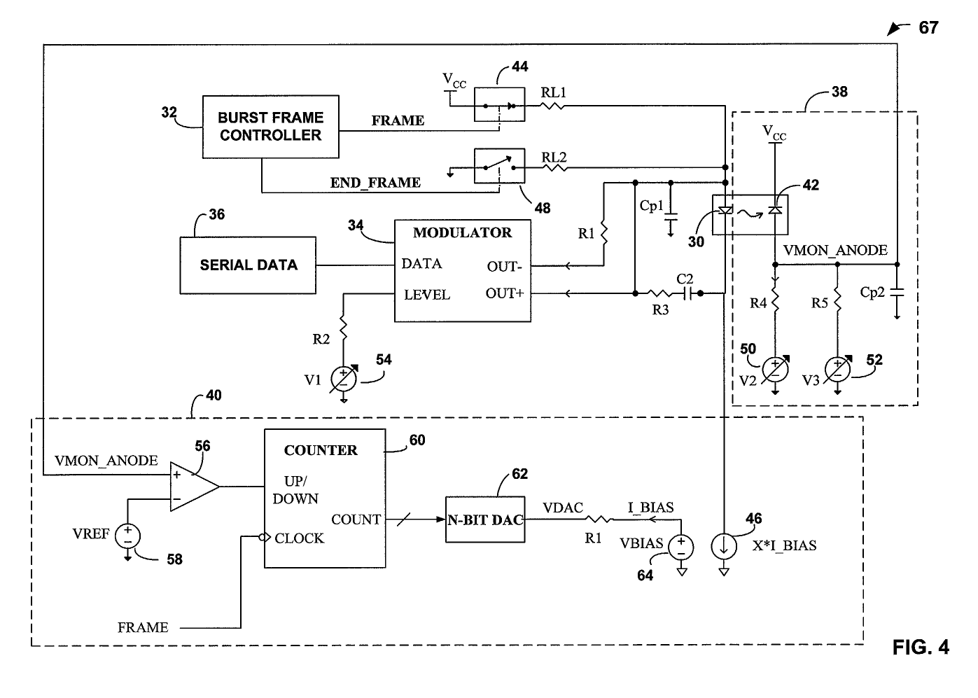

FIG. 4 is a schematic diagram illustrating an exemplary control loop 67 that represents an alternative configuration of control loop 28 of FIG. 3. Control loop 67 conforms substantially to control loop 28, but incorporates an alternative mode for controlling the amount of photodiode current sunk to ground from monitoring photodiode 42. Again, the amount of current sunk to ground from monitor photodiode 42 determines the value of the monitoring voltage VMON_ANODE, and the transfer function between the measured output power of laser diode 30 and the drive current applied to the monitor photodiode. By varying the voltage V2 provided by voltage source 50, the transfer function can be modified.

In practice, there are large variations in the current (Iphoto) from monitor photodiode 42, e.g., approximately ten to one to achieve a given optical power from a given BIDI module supplier. If voltage source 50 is implemented using an inexpensive 8-bit digital-to-analog converter (DAC), however, quantization effects may cause the optical power set-point to be too coarse. In these situations, it may be advantageous to add an additional inexpensive DAC rather than increase the resolution of a single DAC. As an example, if some photodiodes provided in BIDI modules produce an output current of 1 mA at 0 dBm, resistor R4 must be small enough that enough current can be sunk through R4 such that the voltage VMON_ANODE can equal VREF. If the value of resistor R4 is too large, the adjustment range of voltage source V2 may be insufficient to sink 1 mA.

The disadvantage of making resistor R4 small enough to accommodate 1 mA at 0 dBm, however, is that a BIDI module from another manufacturing lot may only output 0.1 mA at 0 dBm, yielding a much coarser adjustment. For this reason, to minimize the quantization effects of a single DAC, a second voltage source 52 may be provided to deliver a voltage V3. By choosing the values of R4 and R5 such that the maximum current sunk through resistor R4 is ⅓ of Iphoto max (1 mA max in this example) and ⅔ of I photomax through R5 (with R5 equal to R4/2), the current resolution per bit can be divided into three ranges as illustrated in Table 1 below.

In summary, the voltages V2 and V3 produced by variable voltage sources 50 and 52, which may be implemented as DACs, can be used together to control the output power of laser diode 30 with fewer quantization effects. With voltages V2 and V3 implemented by two DACs, the photodiode current range can be divided into three different ranges, with each range having a resolution of Iphotomax_range/2ⁿ amps/bit, reducing the quantization effects that would be observed using a single DAC.

TABLE 1

| | Iphotomax | V2 | V3 |
|---|---|---|---|
| Range 1 | 0 to 1/3 | 0 to VREF | VREF |
| Range 2 | 1/3 to 2/3 | VREF | 0 to VREF |
| Range 3 | 2/3 to 1.0 | 0 to VREF | 0 to VREF |

In Table 1, “Iphotomax” represents the maximum current for monitor photodiode 42 that can be expected from a given BIDI module at a particular laser output power. Manufacturing tolerances can cause the photodiode current to be less than 1/10 of Iphotomax to achieve the same laser output power, in which case Range 1 would be selected. In normal operation, the loop drives VMON_ANODE to equal VREF. When the current from monitor photodiode 42 is in the range of 0 to ⅓ of Iphotomax (Range 1), V3 is set to VREF and V2 is adjusted to a value between 0 and VREF. In this case, no current flows between VMON_ANODE and V3, so the value of V2 determines the transfer function of control loop 67. In Range 2, the current from monitor photodiode 42 is between ⅓ and ⅔, and V2 is set to VREF. Accordingly, in Range 2, no current flows between VMON_ANODE and V2, so the value of V3 determines the transfer function. When the current from monitor photodiode 42 falls in Range 3, i.e., ⅔ to 1.0, V2 and V3 are set to vary by substantially the same amount and the photodiode current is (VMON_ANODE−V2)/R4+(VMON_ANODE−V3)/R5 where R5 is R4/2.

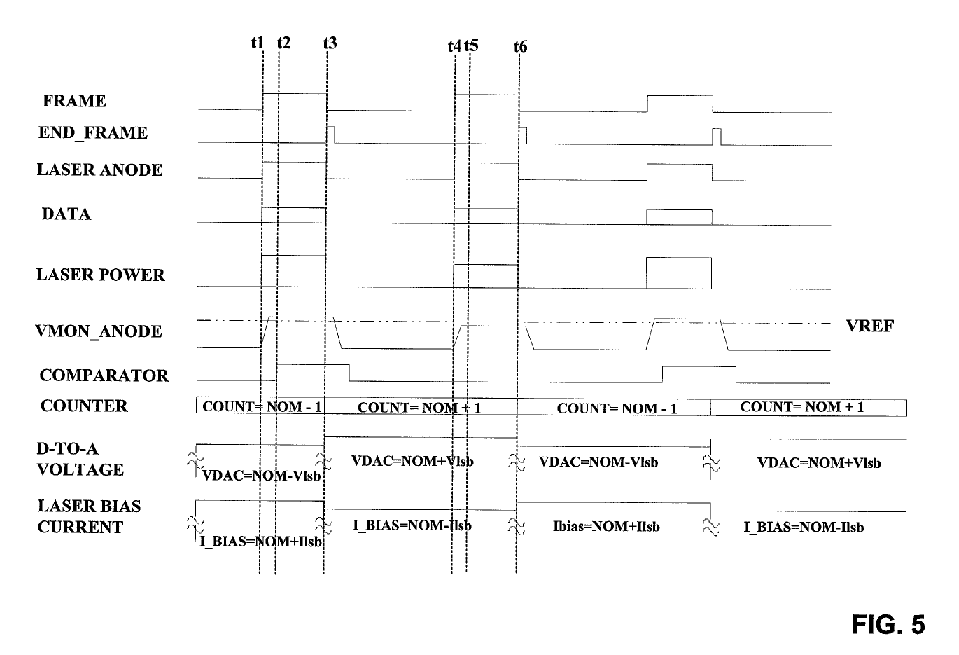

FIG. 5 is a timing diagram further illustrating operation of control loop 28 of FIG. 3. At time t1, the rising edge of the FRAME pulse drives the anode of laser diode 42 high by coupling the anode to VCC. Also, at the time t1, data modulation is enabled, laser power rises, and the monitor voltage VMON_ANODE starts to rise. At time t2, the voltage VMON_ANODE has settled, permitting comparator 56 to produce a stable output value. In the example of FIG. 5, the output of comparator 56 is high at t2 because VMON_ANODE happens to exceed VREF.

At time t3, the falling edge of the FRAME pulse causes the comparator output to be clocked into the up/down input of counter 60. In response, because the comparator output is high, counter 60 increments the existing counter value (Count=NOM+1). Counter 60 then outputs the digital counter value and DAC 62 converts the value to an analog voltage. DAC 62 may use a selected number of least significant bits (Vlsb) of the counter value to produce the output voltage VDAC. The counter value has increased at time t3, so the voltage VDAC also increases (VDAC=NOM+Vlsb).

With a change in the output voltage VDAC, the bias current I_BIAS also changes (I_BIAS=NOM−Ilsb) by an amount (Ilsb) proportional to the change in voltage (Vlsb). The decrease in I_BIAS results in a decrease in the drive current applied to laser diode 30 in the next burst frame, and a decrease in the output power of the laser diode toward the desired level. Also, at time t3, burst frame controller 32 applies the END_FRAME pulse to rapidly turn off laser diode 32. The counter value, VDAC, and I_BIAS remain fixed until the end of the next burst frame.

At time t4, the next FRAME pulse rising edge causes laser diode 30 to burst “on” again. In this case, the modified I_BIAS current from the previous burst frame causes a decrease in the drive current to laser diode 32 in the new burst frame, driving the laser diode output power level toward the desired level. The counter value, VDAC, and I_BIAS remain unchanged until the next falling edge of the FRAME pulse at time t6.

In this example, VMON_ANODE decreases and falls below VREF after application of the FRAME pulse at t4. Comparator 56 goes low after the falling edge of the FRAME pulse at time t3 because laser diode 32 is turned “off,” and VMON_ANODE goes to zero. At time t5, VMON_ANODE has settled and is less than VREF, so the output of comparator 56 simply remains low. On the falling edge of the FRAME pulse at t6, counter 60 responds to the low output of comparator 56 by decrementing the existing counter value (COUNT=NOM−1). The reduced counter value causes a similar reduction in the voltage VDAC produced by DAC 62, and an increase in I_BIAS. As a result, the drive current increases and serves to drive the output power of laser diode 32 back toward the target level again. The process exemplified by the timing diagram of FIG. 5 continues indefinitely, updating control loop 28 on each falling edge of the FRAME pulse.

As mentioned above, the counter value, analog voltage VDAC, and bias current I_BIAS can be held constant for an extended period of time, enabling burst mode operation with extremely small duty cycles. Thus, the values established at the falling edge of a burst frame can be held until they are needed at the rising edge of the next burst frame. In particular, the bias current I_BIAS remains fixed until laser diode 30 bursts “on” again, in which case the drive current applied to the laser diode is a function of the bias current. The control techniques described herein do not suffer from the hold times and leakage currents typically associated with analog sample-and-hold circuitry. In addition, digital counter 60, DAC 62, and other features of control loop 28 or 67 can be readily implemented in low-cost integrated circuitry, e.g., ASIC or FPGA.

As a further advantage, if control loop 28 or 67 is shut down, digital counter 60 can be initialized at startup to hold the last counter value prior to power-down. For example, digital counter 60 may include a preload input that permits a stored value counter value to be loaded into the counter. In this manner, the control loop starts with a good estimate, and is able to stabilize and converge very quickly to a desired output power level upon power-up. This feature can reduce the number of burst frames necessary for the power control loop to stabilize and converge to the desired output power upon power-up.

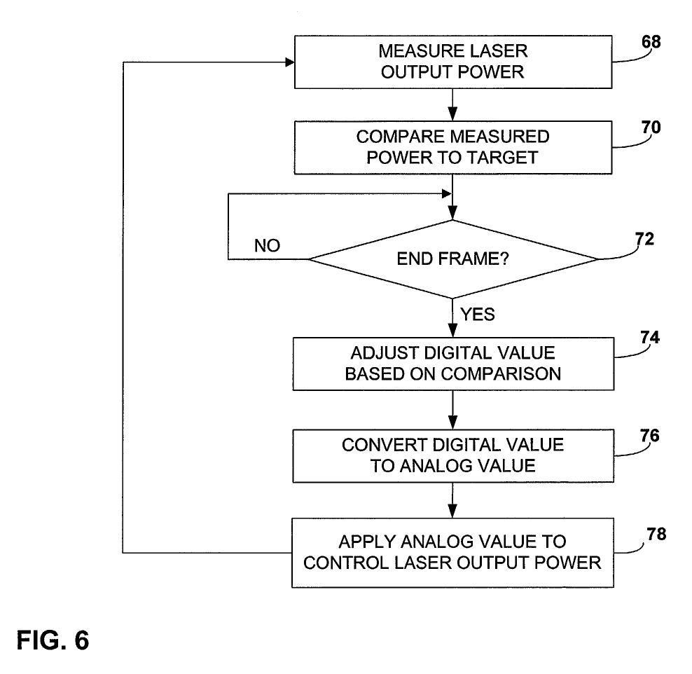

FIG. 6 is a flow diagram illustrating an exemplary digital burst mode laser control technique in accordance with an embodiment of the invention. FIG. 6 generally depicts the operation of control loop 28 and control 67 illustrated in FIGS. 3 and 4, respectively. As shown in FIG. 6, monitor photodiode 42 measures the laser output power (68). Comparator 56 then compares the measured power (VMON_ANODE) to a target level (VREF) (70). At the end of the existing burst frame (72), the control loop 28 adjusts a digital value (74) based on the comparison. The control loop 28 then converts the digital value to an analog value (76), and applies the analog value to control the output power of laser diode 30 during a subsequent frame (78).

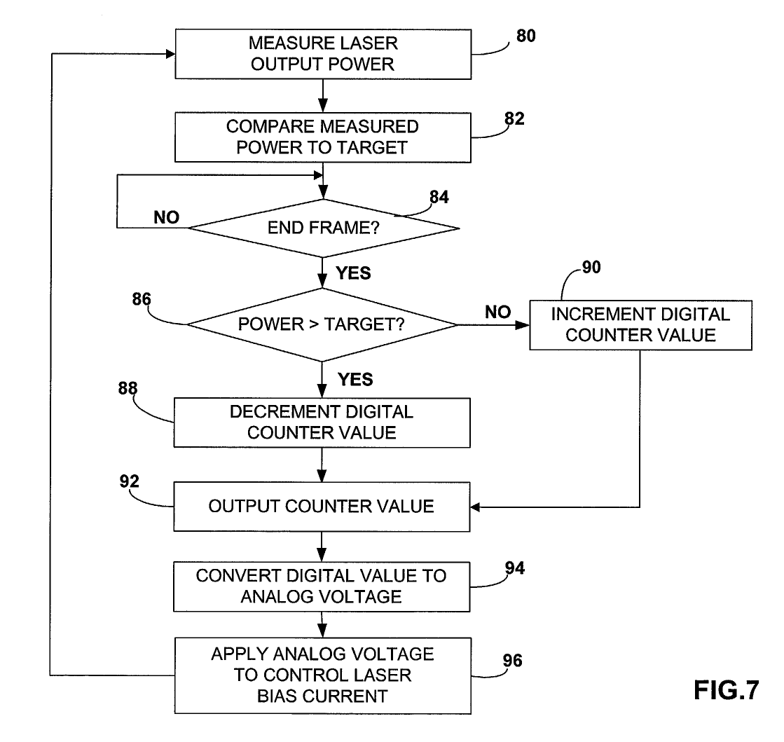

FIG. 7 is a flow diagram illustrating the digital burst mode laser control technique of FIG. 6 in greater detail. As shown in FIG. 7, upon measuring laser output power (80), comparing the measuring power to a target (82), and detecting the end of the present burst frame (84), the control loop decrements a digital counter value (88) if the output power level is greater than the target power level (86). If the output power level is less than the target power level (86), the counter increments the digital counter value (90). Digital counter 60 then outputs the digital counter value (92), converts the digital counter value to an analog voltage (94) and applies the analog voltage to control the laser bias current I_BIAS (96). As described above, the bias current I_BIAS can be used by a laser driver circuit to establish a laser drive current that is applied to laser diode 30.

Various embodiments of the invention have been described. These and other embodiments are within the scope of the following claims.

1. A method comprising:
measuring an output power level of a burst mode laser during a first burst frame;
comparing the measured output power level of the burst mode laser to a target power level;
adjusting a digital value based on the comparison; and
controlling the output power level of the burst mode laser during a second burst frame based on the adjusted digital value.

2. The method of claim 1, wherein controlling the output power level includes controlling a drive current applied to the burst mode laser during the second burst frame.

3. The method of claim 1, wherein controlling the output power level includes:
converting the digital value to an analog value; and
controlling the output power level of the burst mode laser during the second burst frame based on the analog value.

4. The method of claim 1, wherein the analog value is an analog voltage that produces a bias current, the method further comprising controlling a drive current applied to the burst mode laser during the second burst frame based on the bias current.

5. The method of claim 1, wherein adjusting the digital value includes adjusting a digital counter value.

6. The method of claim 1, wherein adjusting the digital value includes:
incrementing a digital counter value when the measured output power level is greater than the target power level; and
decrementing the digital counter value when the measured output power level is less than the target power level.

7. The method of claim 6, further comprising:
outputting the digital counter value from a digital counter in response to a falling edge of a first burst frame pulse associated with the first burst frame;
converting the digital counter value to an analog voltage; and
applying the analog voltage in response to a rising edge of a second burst frame pulse associated with the second burst frame.

8. The method of claim 1, wherein the burst mode laser has a duty cycle of less than approximately one percent, and each of the burst mode frames has a length of less than or equal to approximately 3 microseconds.

9. The method of claim 1, further comprising storing the digital value upon a power-down of the burst mode laser, and retrieving the digital value upon a power-up of the burst mode laser.

10. The method of claim 1, further comprising modulating the burst mode laser to encode data in an output signal emitted by the burst mode laser.

11. A system comprising:
a burst mode laser;
a power monitor that measures an output power level of the burst mode laser during a first burst frame; and
a power controller that compares the measured power level to a target power level, adjusts a digital value based on the comparison, and controls the output power level of the burst mode laser during a second burst frame based on the digital value.

12. The system of claim 11, wherein the power monitor includes a monitor photodiode.

13. The system of claim 11, wherein the digital value is a digital counter value, and the power controller includes:
a comparator that compares the measured power level to the target power level;
a digital counter that adjusts the digital counter value based on the comparison; and
a digital-to-analog converter that converts the digital counter value to an analog voltage that adjusts the output power level of the burst mode laser during the second burst frame.

14. The system of claim 13, wherein the analog voltage controls a bias current, and the bias current controls a drive current applied to the burst mode laser.

15. The system of claim 13, wherein the digital counter:
increments a digital counter value when the measured power level is greater than the target power level; and
decrements the digital counter value when the measured power level is less than the target power level.

16. The system of claim 13, wherein the digital counter outputs the digital counter value in response to a falling edge of a first burst frame pulse associated with the first burst frame, and the analog voltage adjusts the output power level in response to a rising edge of a second burst frame pulse associated with the second burst frame.

17. The system of claim 11, wherein the power controller controls the output power level by controlling a drive current applied to the burst mode laser during the second burst frame.

18. The system of claim 11, wherein the burst mode laser has a duty cycle of less than approximately 1 percent, and each of the burst mode frames has a length between approximately 3 microseconds and approximately 1 millisecond.

19. The system of claim 11, further comprising a modulator that modules the burst mode laser to encode data in an output signal emitted by the burst mode laser.

20. A system comprising:
means for comparing the measured output power level of a burst mode laser to a target power level;
means for adjusting a digital value based on the comparison; and
means for controlling the output power level of the burst mode laser during a second burst frame based on the adjusted digital value.

21. The system of claim 20, wherein controlling means includes means for controlling a drive current applied to the burst mode laser during the second burst frame.

22. The system of claim 20, wherein the controlling means includes means for converting the digital value to an analog value, and means for controlling the output power level of the burst mode laser during the second burst frame based on the analog value.

23. The system of claim 20, wherein adjusting means includes a digital counter that increments a digital counter value when the measured power level is greater than the target power level, and decrements the digital counter value when the measured power level is less than the target power level.

24. The system of claim 20, wherein the burst mode laser has a duty cycle of less than approximately 1 percent, and each of the burst mode frames has a length between approximately 3 microseconds and approximately 1 millisecond.

25. The method of claim 20, further comprising a modulator that modulates the burst mode laser to encode data in an output signal emitted by the burst mode laser.

26. A method comprising:
comparing the measured output power level of a burst mode laser during a first burst mode frame to a target power level;
stepping a digital counter value in a first direction if the output power level is greater than the target power level;
stepping the digital counter value in a second direction if the output power level is less than the target power level; and
converting the digital counter value to an analog voltage to control a drive current applied to the burst mode laser during a second burst frame,
wherein the burst mode laser has a duty cycle of less than approximately 1 percent, and each of the burst mode frames has a length of less than or equal to approximately 3 microseconds.

27. A passive optical network comprising:
a plurality of network nodes;
a passive optical network interface coupled to the nodes, at least in part, by a shared optical fiber link,
wherein the network nodes transmit information to the passive optical network interface in bursts, and each of the nodes includes:
a burst mode laser,
a power monitor that measures an output power level of the burst mode laser during a first burst frame, and
a power controller that compares the measured power level to a target power level, adjusts a digital value based on the comparison, and controls the output power level of the burst mode laser during a second burst frame based on the digital value.
